(19) United States
(12) Patent Application Publication
(10) Pub. No.: US 2023/0004377 A1
(43) Pub. Date: Jan. 5, 2023

(54) INFORMATION PROCESSING DEVICE, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventors: Yu Nagata, Tokyo (JP); Toshihiro Nakamura, Suntou-gun (JP)

(73) Assignee: TOYOTA JIDOSHA KABUSHIKI KAISHA, Toyota-shi (JP)

(21) Appl. No.: 17/834,108

(22) Filed: Jun. 7, 2022

(30) Foreign Application Priority Data
Jun. 30, 2021 (JP) 2021-108416

(51) Int. Cl. G06F 8/65; B60W 50/00

(52) U.S. Cl. CPC G06F 8/65; B60W 50/00; B60W 2050/0083; B60W 2556/65

(57) ABSTRACT

A control unit of an information processing device is configured to perform selecting a first vehicle that is to download first data in place of a second vehicle while the first vehicle is traveling and instructing the first vehicle to download the first data in place of the second vehicle while the first vehicle is traveling and to transmit the first data to the second vehicle. The control unit is configured to select the first vehicle that is to download the first data out of a plurality of vehicles in place of the second vehicle based on a data rate on a scheduled travel route.

### CROSS-REFERENCE TO RELATED APPLICATION

This application claims priority to Japanese Patent Application No. 2021-108416 filed on Jun. 30, 2021, incorporated herein by reference in its entirety.

### BACKGROUND

### 1. Technical Field

The present disclosure relates to an information processing device, an information processing method, and an information processing system.

### 2. Description of Related Art

A system that transmits newest map data from a management center to an onboard device via a communication satellite, in which a vehicle having not received a satellite signal acquires the newest map data from another vehicle having already received the newest map data by vehicle-to-vehicle communication, has been disclosed in Japanese Unexamined Patent Application Publication No. 2007-93260 (JP 2007-93260 A).

### SUMMARY

An aspect of the present disclosure provides an information processing device, an information processing method, and an information processing system that enable a vehicle to reliably acquire data which can be acquired by download regardless of a communication environment.

According to an aspect of the present disclosure, there is provided an information processing device including a control unit configured to perform: selecting a first vehicle that is to download first data in place of a second vehicle while the first vehicle is traveling; and instructing the first vehicle to download the first data in place of the second vehicle while the first vehicle is traveling and to transmit the first data to the second vehicle.

According to another aspect of the present disclosure, there is provided an information processing method including: selecting a first vehicle that is to download first data in place of a second vehicle while the first vehicle is traveling; and instructing the first vehicle to download the first data in place of the second vehicle while the first vehicle is traveling and to transmit the first data to the second vehicle.

According to another aspect of the present disclosure, there is provided an information processing system including a plurality of vehicles and an information processing device including a control unit configured to perform: selecting a first vehicle that is to download first data out of the plurality of vehicles in place of a second vehicle while the first vehicle is traveling; and instructing the first vehicle to download the first data in place of the second vehicle while the first vehicle is traveling and to transmit the first data to the second vehicle.

According to an aspect of the present disclosure, a vehicle can reliably acquire data which can be acquired by download regardless of a communication environment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a system configuration of an information processing system according to a first embodiment;

FIG. 2 is a diagram illustrating an example of an alternative update data downloading process according to the first embodiment;

FIG. 3 is a diagram illustrating an example of a release note;

FIG. 4 is a diagram illustrating an example of a hardware configuration of a control center;

FIG. 5 is a diagram illustrating an example of a functional configuration of the control center;

FIG. 6 is a diagram illustrating an example of schedule information stored in a schedule information database of the control center;

FIG. 7 is a diagram illustrating an example of vehicle information stored in a vehicle information database of the control center;

FIG. 8 is a flowchart illustrating an example of an update schedule preparing process in response to reception of a release note which is performed by the control center; and

FIG. 9 is a flowchart illustrating an example of an alternative vehicle identifying process.

### DETAILED DESCRIPTION OF EMBODIMENTS

An aspect of the present disclosure provides an information processing device comprising a control unit. The control unit is configured to perform: selecting a first vehicle that is to download first data in place of a second vehicle while the first vehicle is traveling; and instructing the first vehicle to download the first data in place of the second vehicle while the first vehicle is traveling and to transmit the first data to the second vehicle.

The information processing device may be, for example, a server that manages a plurality of vehicles. The present disclosure is not limited thereto. Vehicles that are managed by the information processing device include a first vehicle and a second vehicle. The vehicles managed by the information processing device may be, for example, vehicles that can travel autonomously or travel automatically. The present disclosure is not limited thereto, and the vehicles managed by the information processing device may be vehicles that travel with a driver's operation, have a communication function, and have a plurality of programs installed therein. The control unit may be, for example, a processor such as a central processing unit (CPU). An example of an instruction for a vehicle is to prepare and transmit a schedule for the vehicle. The present disclosure is not limited thereto.

In the aspect of the present disclosure, for example, even when the second vehicle travels or parks in an area with a poor communication environment, the first vehicle can download first data in place of the second vehicle and transmit the downloaded first data to the second vehicle. Accordingly, the second vehicle can stably acquire the first data.

In the aspect of the present disclosure, the control unit may select the first vehicle that is to download the first data out of a plurality of vehicles in place of the second vehicle based on a data rate on a scheduled travel route. In this case, the control unit may select the first vehicle when a data rate in a scheduled travel route of the second vehicle is less than a first threshold value. The plurality of vehicles is vehicles that are managed by the information processing device. The data rate in a scheduled travel route may be acquired, for example, from a data rate map in which results of measurement of a downlink data rate measured at all points are plotted on a map. According to an aspect of the present disclosure, it is possible to determine whether a communication environment is good or poor based on the data rate in each scheduled travel route.

In the aspect of the present disclosure, the control unit may select the first vehicle out of the plurality of vehicles additionally based on a communication load. In this case, the control unit may select a vehicle in which the communication load is less than a second threshold value and the data rate is highest as the first vehicle out of a plurality of vehicles. For example, when a vehicle managed by the information processing device is a vehicle traveling autonomously or traveling automatically, a communication process load is increased due to traveling. The communication load may increase by causing the vehicle traveling autonomously or traveling automatically to download the first data in traveling, and there is a likelihood of traveling of the vehicle being affected. Accordingly, it is possible to secure traveling safety of a vehicle selected as the first vehicle by selecting the first vehicle in consideration of the communication load. The communication load may be an estimated value.

In the aspect of the present disclosure, the control unit may acquire a communication load of each of the plurality of vehicles based on a type of a road included in a scheduled travel route of each of the plurality of vehicles. Examples of the road type include a highway and a public road. For example, a highway is likely to have a smaller communication load based on traveling than that of a public road because there are no signals, longer straight sections, and no pedestrians in comparison with the public road. According to the aspect of the present disclosure, a communication load of a vehicle can be acquired from a type of a road included in a scheduled travel route.

In the aspect of the present disclosure, the control unit may select the first vehicle out of a plurality of vehicles which is scheduled to join the second vehicle. In this case, the control unit may instruct the first vehicle to transmit the first data to the first vehicle at a junction with the first vehicle. Accordingly, a vehicle that can reliably transmit the first data to the second vehicle can be selected as the first vehicle.

In the aspect of the disclosure, the first data may be updating data of a program which is installed in the second vehicle. In this case, the control unit may further perform instructing the second vehicle to receive the first data from the first vehicle and to update the program with the first data. Accordingly, even when the second vehicle is located in an area with a poor communication environment, the second vehicle can acquire updating data of a program and update the program.

In the aspect of the present disclosure, the first vehicle may download the first data by first communication using a relay and transmit the first data to the second vehicle by second communication not using a relay. The first communication is, for example, communication based on a mobile communication system such as 5th Generation (5G), Long Term Evolution (LTE), or 6th Generation (6G). The second communication is, for example, a radio communication system such as Bluetooth (registered trademark) and Wi-Fi. Accordingly, even when the second vehicle is located in an area with a poor communication environment of the first communication, the second vehicle can acquire the first data from the first vehicle by the second communication.

Other aspects of the present disclosure can be realized as an information processing method including processes of the information processing device, a program causing a computer to perform the processes of the information processing device, and a non-transitory computer-readable recording medium storing the program. Another aspect of the present disclosure can also be realized as an information processing system including a plurality of vehicles and the information processing device.

Hereinafter, embodiments of the present disclosure will be described with reference to the accompanying drawings. The configurations of the following embodiments are merely examples, and the present disclosure is not limited to the configurations of the embodiments.

### First Embodiment

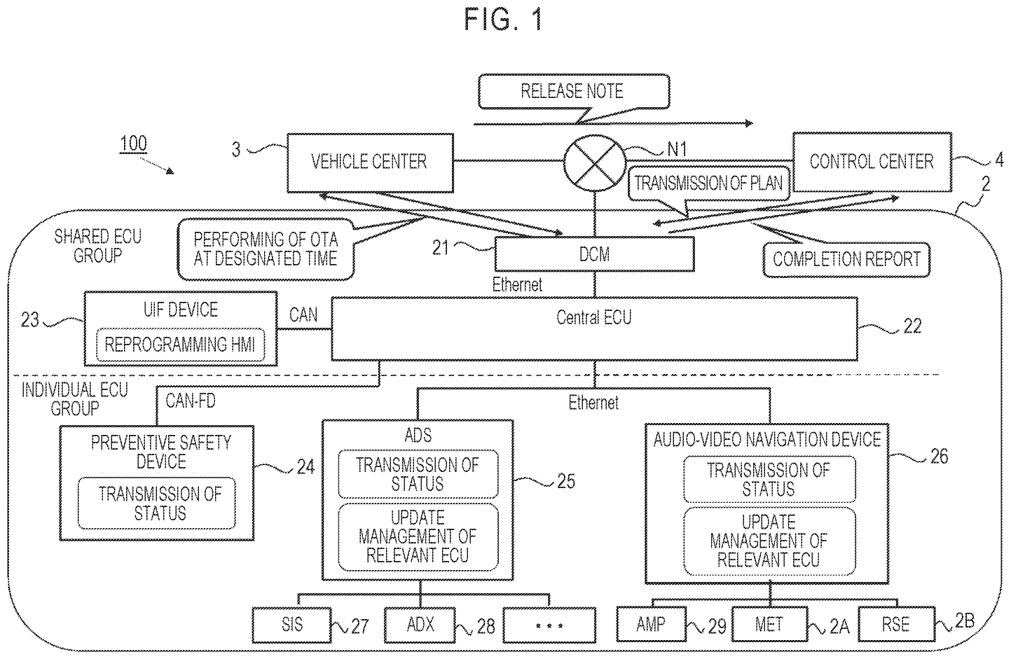

FIG. 1 is a diagram illustrating an example of a system configuration of an information processing system 100 according to a first embodiment. The information processing system 100 includes a vehicle 2, a computer of a vehicle center 3, and a computer of a control center 4. In the following description, the computer of the vehicle center 3 and the computer of the control center 4 are also simply referred to as the vehicle center 3 and the control center 4. The vehicle 2, the vehicle center 3, and the control center 4 are connected via a network N1.

The network N1 includes a wired network and a wireless network. The wired network is also referred to as, for example, a core network or a backbone and is a broadband network such as optical fiber. The wireless network includes, for example, a mobile phone network such as Long Term Evolution (LTE), 5G, or 6G.

The vehicle 2 is, for example, an automobile. The vehicle may have four wheels, three wheels, or two wheels. The vehicle may be operated by an engine or may be operated by a motor. The vehicle may be a vehicle in which an automated driving system that enables automated driving or automatic traveling is mounted.

As illustrated in FIG. 1, the vehicle 2 includes a data communication module (DCM) 21, a central electrical control unit (central ECU) 22, a user interface (UIF) device 23, a preventive safety device 24, an advanced drive system (ADS) 25, and an audio-video navigation device 26.

The DCM 21 accesses the network N1 and communicates with another mobile object, the vehicle center 3, the control center 4, and the like. The DCM 21 can perform radio communication via a mobile communication network.

The central ECU 22 manages devices in the vehicle 2. The central ECU 22 includes, for example, a processor and a memory. The processor performs processes of the central ECU 22 by executing a computer program in the memory. The central ECU 22 updates computer programs which are executed by ECUs provided in the devices in the vehicle 2 and manages updating progress. The central ECU 22 detects an error when a computer program is updated and performs a process at the time of occurrence of an error. A combination of the central ECU 22 and the DCM 21 is an example of a computer mounted in the vehicle.

The UIF device 23 provides a user interface, for example, when a computer program which is executed by an ECU provided in each device in the vehicle 2 is updated. This user interface is also referred to as a reprogramming human-machine interface (a reprogramming HMI). The UIF 23 includes the same EC as the central ECU 22. The central ECU 22, the ECU in the UIF device 23, and the like can be referred to as a shared ECU group.

The preventive safety device 24 includes an ECU and performs a collision avoidance support process by executing a computer program. The preventive safety device 24 performs, for example, support for avoidance of collision, warning of lane departure, automatic high beam control, and radar cruise control based on signals from sensors such as a radar and a camera.

A spatial information service (SIS) 27 and an advanced drive extension (ADX) 28, and the like are connected to the ADS 25. The ADS 25, the SIS 27, and the ADX 28 have ECUs therein and perform an advanced drive support process by executing computer programs. The ADS 25 detects a vehicle, a three-dimensional object, and the like near the vehicle 2, for example, based on a detection signal from a light detection and ranging (LiDAR) unit, estimates a position of the vehicle 2, and performs motion control.

The SIS 27 supplies a posture, a position on a map, and the like of the vehicle 2 to the ADS 25. That is, the SIS 27 acquires position information from a global navigation satellite system (GNSS) or a global positioning system (GPS), six-axis acceleration signals from a gyro sensor, route information or map information from a navigation system, and the like. The SIS 27 calculates the position, the position on a map, and the like of the vehicle 2 based on the acquired information. The ADX 28 employs an artificial intelligence (AI) system, recognizes and processes information from various sensors and the like, and transmits processing results to the ADS 25.

An automated mapping platform (AMP) 29, a MET 2A, and a rear-seat entertainment (RSE) 2B are connected to the audio-video navigation device 26. The audio-video navigation device 26, the AMP 29, the MET 2A, and the RSE 2B have ECUs therein and provide various functions using audio, video, map information, and the like to a user of the vehicle 2 by executing computer programs.

The AMP 29 generates map information from data such as images collected by a sensor such as a camera mounted in the vehicle 2. The RSE 2B provides television broadcasts, digital versatile disc (DCD) video, and the like to a user sitting on a rear seat on the rear seat of a cabin when the vehicle 2 is a vehicle including a rear seat.

The ECUs of the preventive safety device 24, the ADS 25, and the audio-video navigation device 26 and ECUs of devices connected thereto are referred to as an individual ECU group. The central ECU 22 manages updating progress and updating errors of computer programs installed in the individual ECU group.

The vehicle center 3 is operated by an organization such as a company that sells the vehicle 2 or repairs the vehicle 2 or a company entrusted by the company or the like. The vehicle center 3 manages components such as ECUs mounted in all mobile objects which are sold or repaired by such companies. The vehicle center 3 manages types and versions of computer programs which are executed by the ECUs. The vehicle center 3 transmits updating data for updating the computer programs to the vehicle 2 and the like. Updating data can also be simply referred to as an update program.

The control center 4 manages travel, maintenance, and the like of each vehicle 2. The control center 4 is, for example, a computer of a fleet management service (FMS) company providing an FMS. The control center 4 manages a schedule for use in sharing including a travel start date and time, a travel end date and time, and a maintenance date and time of a vehicle 2 in a service which is aperiodically used, for example, a ride sharing service. The control center 4 manages a schedule for rental of a vehicle 2 which is used in rental. The control center 4 appropriately updates the schedules, distributes the updated schedules to the vehicles 2, and manages operations of the vehicles 2. In the following description, a schedule may indicate the whole schedule for one day, one week, one month, or the like and may indicate one item in which one or more events such as movement between two predetermined points and update of a program are performed. For example, expressions such as “prepare a schedule” and “plan a schedule” are used for one item of a schedule.

As described above, various components including an ECU are mounted in a vehicle 2. Computer programs which are executed by the ECUs of the components are updated with improvement or countermeasures for inconvenience. Safety is required for the vehicle 2. Accordingly, updating of computer programs for the ECUs in the vehicle 2 is performed while the vehicle 2 has stopped traveling.

The vehicle center 3 notifies the control center 4 of a schedule for transmission of newest updating details and updating data for the computer programs of the ECUs in the form of a release note. The control center 4 adds updating of the computer programs of the ECUs to schedules of the vehicles 2 when a release note is received. That is, the control center 4 plans a schedule for a vehicle 2 such that updating of the computer programs of the ECUs is completed in a maintenance period in which the vehicles 2 are not traveling. The control center 4 notifies the vehicles 2 of the determined schedules (transmission of a plan in FIG. 1) such that the computer programs of the ECUs are updated.

The DCM 21 of a vehicle 2 communicates with the vehicle center 3 and the control center 4 via the network N1. The DCM 21 receives a schedule including updating of a computer program from the control center 4 (transmission of a plan in FIG. 1). The central ECU 22 is connected to the DCM 21 via a network in a mobile object such as Ethernet (registered trademark).

The DCM 21 accesses the vehicle center 3 according to the received schedule, acquires updating data for updating a computer program, and transmits the acquired updating data to the central ECU 22. The central ECU 22 updates the computer programs of the ECUs including the shared ECU group and the individual ECU group in a maintenance period in which the vehicle 2 is stopped. The DCM 21 notifies the control center 4 of a completion report when updating of the ECUs by the central ECU 22 is completed.

The UIF device 23 is connected to the central ECU 22, for example, via a network in a mobile object such as a controller area network (CAN (registered trademark)). The UIF device 23 may receive an input of ascertainment by a user's operation using the reprogramming HMI. That is, the central ECU 22 may request the user to ascertain updating start of a computer program using the UIF device 23 and start the updating after ascertainment has been acquired. The UIF device 23 acquires updating data from the central ECU 22, and a computer program of the UIF device 23 is updated.

The preventive safety device 24 is connected to the central ECU 22, for example, via a network in the vehicle 2 such as a controller area network with flexible data rate (CAN-FD (CAN is a registered trademark)). The preventive safety device 24 receives updating data of a computer program from the central ECU 22 and performs updating. Then, the preventive safety device 24 reports a status with the updating to the central ECU 22.

The ADS 25 and the audio-video navigation device 26 are connected to the central ECU 22, for example, via a network in a mobile object such as Ethernet (registered trademark). The ADS 25 and the audio-video-navigation device 26 receive updating data of a computer program from the central ECU 22. Then, the ADS 25 and the audio-video-navigation device 26 perform updating of computer programs of the ECUs of themselves and loads thereof. The ADS 25 and the audio-video navigation device 26 reports a status with the updating to the central ECU 22. In this flow, updating of a program in a normal vehicle 2 based on issuance of a release note is performed.

In the first embodiment, the control center 4 determines whether a communication environment of an area in which a vehicle 2 having a program to be updated in a release note installed therein is located in a predetermined period after a transmission start date and time of the updating data is good or poor. For example, when a vehicle 2 is traveling in an area with a poor communication environment and a parking place is in the area, there is a high likelihood that the vehicle 2 will not be able to stably download updating data because downloading of the updating data may be stopped or require too long a time. Therefore, in the first embodiment, the control center 4 causes another vehicle 2 to download the updating data in place of the vehicle 2.

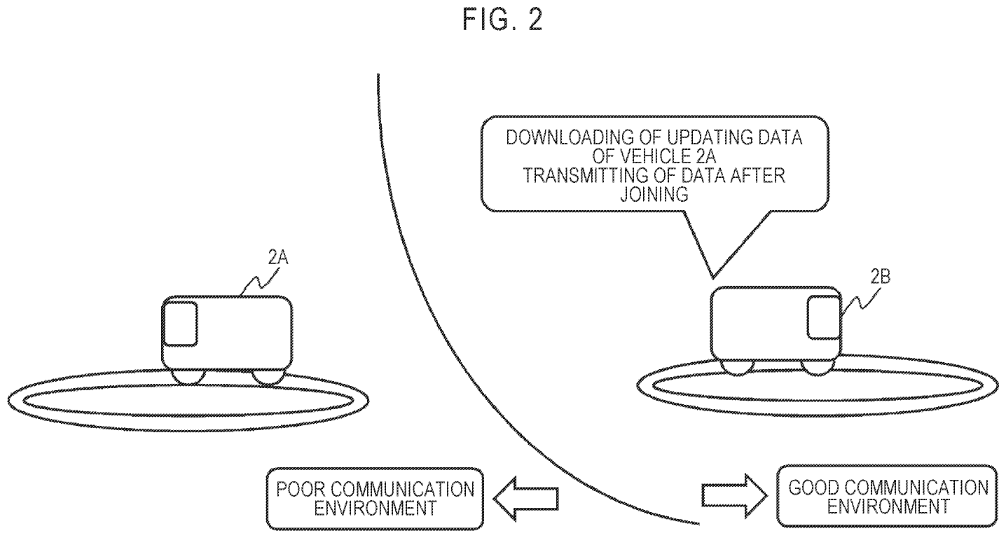

FIG. 2 is a diagram illustrating an example of a process of alternatively downloading updating data according to the first embodiment. The control center 4 receives a release note from the vehicle center 3 and identifies a vehicle 2A in which a program to be updated in the release note is installed. The control center 4 detects that the vehicle 2A is located in an area with a poor communication environment in a predetermined period after a transmission start date and time of the updating data, for example, from a schedule for the vehicle 2A. Whether a communication environment is good or poor is determined, for example, based on data rates obtained at various points acquired from a data rate map.

For example, when the data rate is less than a predetermined threshold value, it is determined that the communication environment is poor. The data rate map is, for example, a map on which results of measurement of a downlink data rate at various points are plotted in mobile communication systems published for communication carriers. Not limited thereto, the data rate map may indicate theoretical downlink data rates. A downlink data rate is a data rate in a direction from a base station to a terminal and is also referred to as a receiving data rate.

The control center 4 selects the vehicle 2B which is caused to download the updating data in place of the vehicle 2A out of vehicles 2 which are scheduled to travel in an area with a good communication environment and to join the vehicle 2A after the transmission start date and time of the updating data. Joining in the vehicle 2A includes, for example, situations in which a parking place, a waiting place, or a maintenance place is the same.

The control center 4 prepares a schedule including downloading of updating data while traveling in an area with a good communication environment and a schedule including transmitting of the updating data to the vehicle 2B for the vehicle 2B and transmits the prepared schedules to the vehicle 2B. The control center 4 prepares a schedule for the vehicle 2A including receiving of the updating data from the vehicle 2B and updating a corresponding program using the received updating data and transmits the prepared schedule to the vehicle 2A.

The vehicle 2A and the vehicle 2B communicate with the control center 4 and the vehicle center 3 by accessing the network N1 using a mobile communication system in the first embodiment. Accordingly, the vehicle 2A and the vehicle 2B can communicate directly with each other, for example, by short-range radio communication such as Bluetooth (registered trademark), and transmission and reception of updating data are performed by the short-range radio communication such as Bluetooth (registered trademark). The vehicle 2A is an example of a “second vehicle.” The vehicle 2B is an example of a “first vehicle.” The mobile communication system is an example of “first communication.” The short-range radio communication such as Bluetooth (registered trademark) is an example of “second communication.”

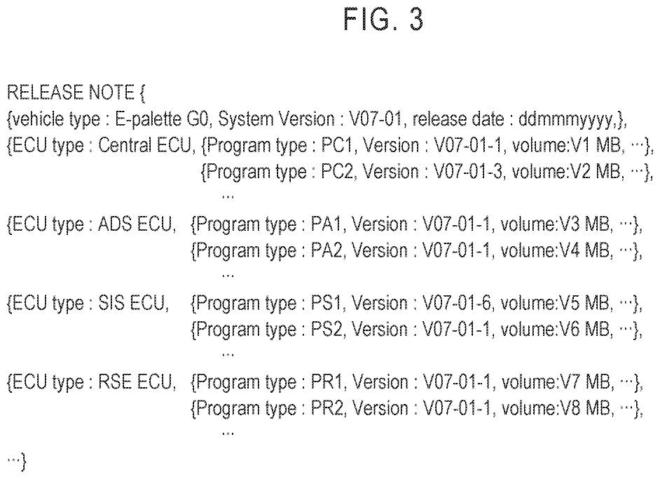

FIG. 3 illustrates an example of a release note. The release note is transmitted from the vehicle center 3 to the control center 4. In the example illustrated in FIG. 3, a value with respect to a keyword is designated in the form of “keyword:value” in the release note. In the example illustrated in FIG. 3, groups of “keyword:value” are enclosed with curly brackets “{ }” and are shown hierarchically.

In the example illustrated in FIG. 3, a type of a vehicle (vehicle type), a version of a system to be released (system version), a transmission start date and time (release date), a type of an ECU (ECU type), a type of a program to be released (program type), a version of a program to be released (Version), and a size of updating data (volume) are included as keywords in the release note.

That is, in the example illustrated in FIG. 3, the release note indicates that transmission of updating data for a system with a version V07-01 in a vehicle 2 with a type E-palette G0 is started at a date dd/mm/yyyy. Here, the version of a system (system version) is a version which is given to the whole computer program group which is installed in a vehicle 2. In the release note, a type and a version of a program, a data size (volume) of updating data, and the like are described for each type of ECU (ECU type). For example, it can be seen that the version of PC1 which is a program of a central ECU is V07-01-1 and the data size thereof is V1 MB.

The form of the release note is not limited to the example illustrated in FIG. 3. For example, the release note may be described in a predetermined format such as hyper text markup language (HTML) or extensible markup language (XML). The release note may be described in the form of a table in which records including a plurality of elements are arranged.

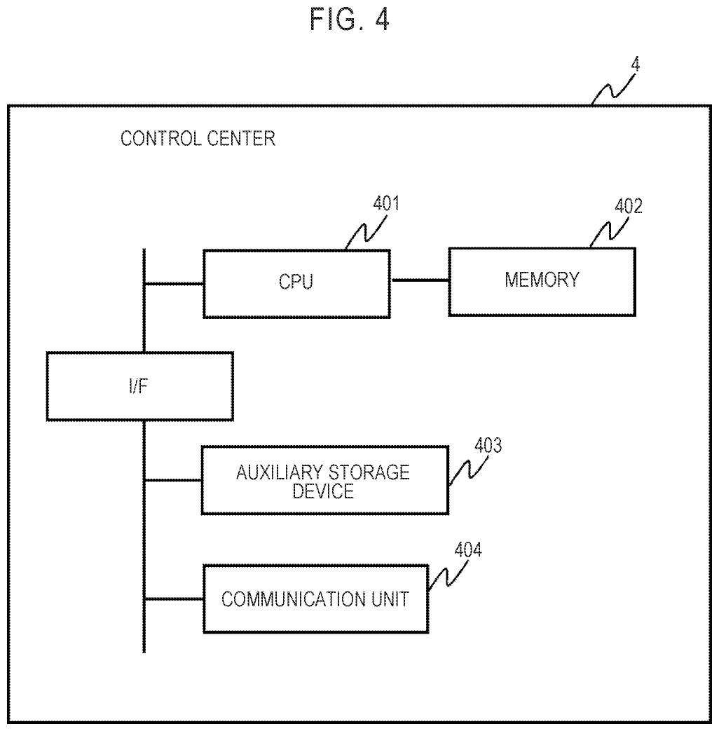

FIG. 4 is a diagram illustrating an example of a hardware configuration of the control center 4. The control center 4 is, for example, a server. The control center 4 includes a CPU 401, a memory 402, an auxiliary storage device 403, and a communication unit 404 as hardware constituents. The computer of the control center 4 is an example of an “information processing device.”

The CPU 401 is connected to an external device via an interface (I/F) and performs predetermined processes by executing programs. The CPU 401 is a processor. The CPU 401 is not limited to a single processor but may have a configuration of multiple processors. The CPU 401 may include a graphic processing unit (GPU) and a digital signal processor (DSP). The CPU 401 may cooperate with a hardware circuit such as a field programmable gate array (FPGA). Examples of the external device connected to the CPU 401 via the (I/F) include the auxiliary storage device 403 and the communication unit 404. In addition, for example, an output device such as a display and an input device such as a keyboard and a mouse may be connected to the CPU 401 via the interface (I/F). The CPU 401 is an example of a “control unit.”

The CPU 401 provides a function of the control center 4 by executing computer programs which are executably loaded to the memory 402. The memory 402 stores the computer programs executed by the CPU 401, data processed by the CPU 401, and the like. The memory 402 includes a dynamic random access memory (DRAM), a static random access memory (SRAM), or a read only memory (ROM). The auxiliary storage device 403 is used, for example, as a storage area for assisting the memory 402. The auxiliary storage device 403 stores computer programs executed by the CPU 401, data processed by the CPU 401, and the like. The auxiliary storage device 403 includes a hard disk drive (HDD), a solid state disk (SSD), or the like. A drive device for a detachable storage medium may be provided in the control center 4. Examples of the detachable storage medium include a Blu-ray disc, a digital versatile disk (DCD), a compact disc (CD), and flash memory card.

The communication unit 404 transmits and receives data to and from another device over a network. For example, the communication unit 404 communicates with the DCM 21 via the network N1. The communication unit 404 is, for example, a wired network card such as a local area network (LAN) or a dedicated line and is connected to the network N1 via an access network such as the LAN. The hardware configuration of the control center 4 is not limited to the example illustrated in FIG. 4.

Similarly to the control center 4, the vehicle center 3 includes a CUP, a memory, an auxiliary storage device, and a communication unit. The DCM 21 includes a CPU, a memory, an auxiliary storage device, and a radio communication unit. The radio communication unit of the DCM 21 is a radio communication circuit corresponding to a mobile communication system such as 5G, LTE, LTE-Advanced, or 3G or a radio communication system such as WiFi. The radio communication unit is connected to an access network by radio communication and is connected to the network N1 via the access network.

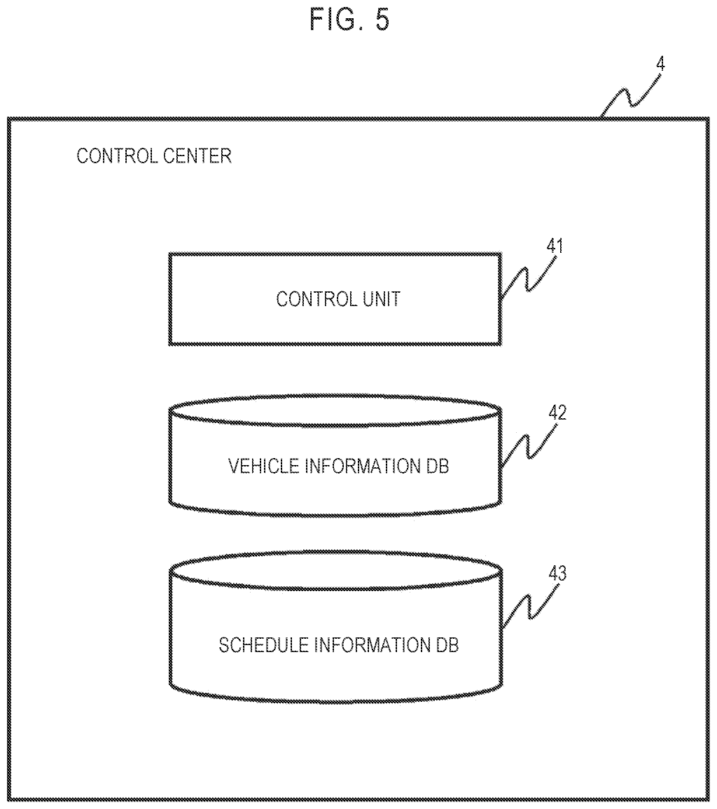

FIG. 5 is a diagram illustrating an example of a functional configuration of the control center 4. The control center 4 includes a control unit 41, a vehicle information database (DB) 42, and a schedule information DB 43 as functional constituents. These functional constituents are realized, for example, by causing the CPU 404 of the control center 4 to execute predetermined programs.

The control unit 41 manages travel of each vehicle 2. The control unit 41 receives a release note from the vehicle center 3 via the communication unit 404. When the release note is received, the control unit 41 extracts vehicles 2 of which programs are to be updated and prepares an update schedule for each vehicle 2. In the release note illustrated in FIG. 3, the vehicles 2 to be updated in the release note are vehicles 2 which correspond a type of a vehicle (vehicle type) and a version of a system (system version) included in the release note and of which the latest update date is earlier than a transmission start date (release date) included in the release note.

In the first embodiment, the control unit 41 prepares a schedule for a vehicle 2 located in an area with a poor communication environment such that another vehicle 2 downloads updating data and transmits the updating data to the vehicle 2 to be updated. In other updating, for example, the control unit 41 adds downloading and updating of updating data indicated by the release note to a first schedule for maintenance or standby after the transmission start date and time of the release note.

The control unit 41 determines whether the vehicle 2 to be updated in the release note is located in an area with a good communication environment in a predetermined period after the transmission start date and time. The predetermined period after the transmission start date and time is, for example, a time period after the transmission start date and time in the transmission start date. The predetermined period is not limited thereto and may be, for example, 24 hours or one week after the transmission start date and time.

In the first embodiment, whether a communication environment is good or poor is determined based on a data rate. Specifically, when data rates acquired in an area in which the vehicle 2 travels and a place in which the vehicle 2 parks or is subjected to maintenance in the predetermined period after the transmission start date and time are less than a predetermined threshold value, the control unit 41 determines that the communication environment is poor. The predetermined threshold value may be set, for example, in a range of 1 Mbps to 5 Mbps. The control unit 41 identifies the area in which the vehicle 2 travels and the place in which the vehicle 2 parks or is subjected to maintenance in the predetermined period after the transmission start date and time with reference to the schedule information DB 43. The control unit 41 acquires a data rate in a specific place from a data rate map of a communication carrier which is employed by the vehicle 2. The control unit 41 identifies a communication carrier employed by the vehicle 2 with reference to the vehicle information DB 42.

The control unit 41 selects a vehicle 2 that is to download updating data in place of the vehicle 2. In the following description, the vehicle 2 to be updated is referred to as a target vehicle. Downloading of updating data in place of the vehicle 2 is referred to as alternative downloading. The vehicle 2 that performs alternative downloading is referred to as an alternative vehicle. The alternative vehicle is selected from vehicles that are scheduled to join the target vehicle in a predetermined period after the transmission start date and time and that have a good communication environment in an area in which they are traveling out of the vehicles 2 managed by the control center 4. In the following description, an area in which a vehicle 2 travels is simply referred to as a traveling area. The traveling area is an area including a travel route or a scheduled travel route of the vehicle 2. The target vehicle is an example of a “second vehicle.” The alternative vehicle is an example of a “first vehicle.” The updating data is an example of “first data.”

A schedule for joining a target vehicle is a schedule for standby or maintenance in the same place as the target vehicle. Here, the schedule for joining a target vehicle is not limited thereto. A schedule and a traveling area in a predetermined period after the transmission start date and time for each vehicle 2 are acquired with reference to the schedule information DB 43. In the first embodiment, whether a communication environment of each vehicle 2 is good or poor is determined based on a data rate. When the data rate acquired in a traveling area is equal to or greater than a predetermined threshold value, the control unit 41 determines that the communication environment of the corresponding vehicle is good. The threshold value for determining whether a communication environment of a vehicle 2 is good or poor may be equal to or different from the threshold value for determining whether a communication environment of a target vehicle is good or poor. A data rate acquired in a traveling area of each vehicle 2 is acquired, for example, from a data rate map of a communication carrier employed by the corresponding vehicle 2.

The control unit 41 additionally extracts a vehicle 2 of which a predicted communication load is less than a threshold value out of the extracted vehicles 2. The predicted communication load of a vehicle 2 is an estimated value acquired based on a type of a road included in a route along which the vehicle 2 travels in a predetermined period after the transmission start date and time. For example, the type of a road includes a general road and a highway. In a general road, a process load of a vehicle 2 based on communication with x4 for the traveling is likely to increase in comparison with a highway due to traffic signals, right turn or left turn, narrow roads, pedestrians, vehicles traveling in an oncoming lane, and the like. Accordingly, a communication load associated with each vehicle 2 is higher when it is traveling in a general road than when it is traveling in a highway. The control unit 41 acquires a predicted communication load when a vehicle is traveling in a highway and a predicted communication load when a vehicle is traveling in a general load, for example, from travel histories and stores the acquired predicted communication loads in the auxiliary storage device 403. A predicted communication load is expressed, for example, as a proportion. A threshold value for the predicted communication load used to extract a vehicle 2 is, for example, 80%.

The control unit 41 selects a vehicle 2 in which a data rate acquired in a traveling area is the highest as an alternative vehicle out of vehicles 2 of which the predicted communication load is less than the threshold value. The data rate of a vehicle 2 may be one of an average value, a minimum value, a median value, and a maximum value of data rates acquired in a traveling area of the vehicle 2 in a predetermined period after the transmission start date and time.

The control unit 41 prepares a schedule for downloading updating data while an alternative vehicle is traveling and a schedule for transmitting the updating data to a target vehicle by short-range radio communication such as Bluetooth (registered trademark) in a place in which it joins the target vehicle for the alternative vehicle. The schedule for downloading updating data in traveling is prepared, for example, by adding downloading of updating data to an existing schedule including traveling after a start time of a schedule corresponding to the schedule for joining the target vehicle after the transmission start date and time. The schedule for transmitting the updating data to the target vehicle is prepared, for example, by adding transmitting of the updating data to the target vehicle to the schedule corresponding the schedule for joining the target vehicle after the transmission start date and time.

The control unit 41 prepares a schedule for receiving updating data from an alternative vehicle by short-range radio communication in a place in which a target vehicle joins the alternative vehicle and a schedule for updating a target program with the updating data for the target vehicle. The schedule for receiving updating data from an alternative vehicle is prepared, for example, by adding receiving of updating data from the alternative vehicle to the schedule corresponding to the schedule for joining the alternative vehicle after the transmission start date and time. The schedule for updating a target program is prepared, for example, by adding receiving of updating data from the alternative vehicle to an existing schedule for first standby or maintenance after the schedule for receiving the updating data from the alternative vehicle.

The control unit 41 registers the prepared schedules for the target vehicle and the alternative vehicle in the schedule information DB 43 and transmits the schedules to the target vehicle and the alternative vehicle. For example, information included in a corresponding release note and information on the target vehicle and the alternative vehicle are also transmitted along with the schedules for the target vehicle and the alternative vehicle prepared by the control unit 41. The information included in the release note is, for example, the same as illustrated in FIG. 3. The information on the target vehicle and the alternative vehicle includes, for example, identification information of the target vehicle and the alternative vehicle and information used for short-range radio communication. When a schedule is transmitted to a vehicle 2 such that the vehicle 2 performs operations and processes corresponding to the schedule from the control center 4, it means that the vehicle 2 is instructed to perform the operations or processes.

The vehicle information DB 42 and the schedule information DB 43 are prepared in a storage area in the auxiliary storage device 403 in the control center 4. The vehicle information DB 42 stores information on vehicles 2. The schedule information DB 43 stores information on schedules for the vehicles 2.

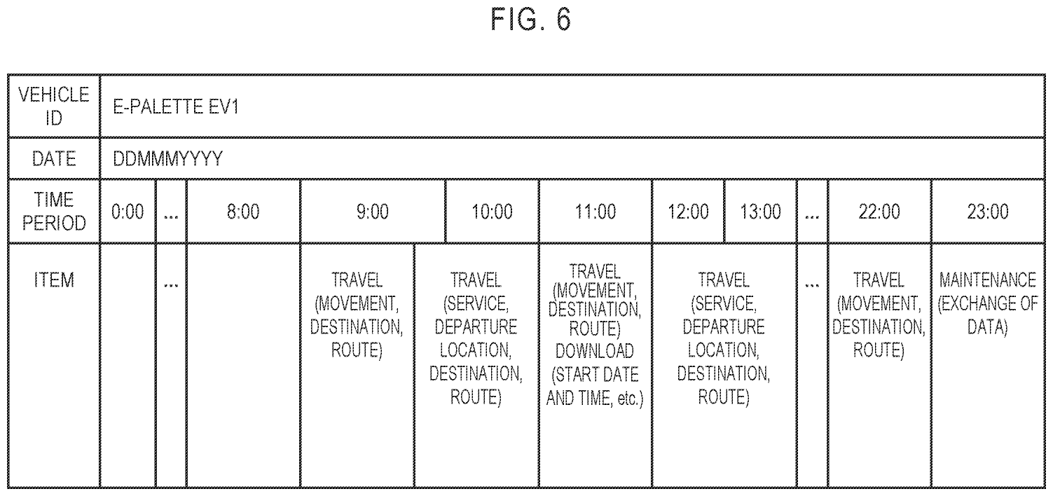

FIG. 6 illustrates an example of information on a schedule stored in the schedule information DB 43 of the control center 4. The schedule is prepared for each vehicle 2. The information on a schedule illustrated in FIG. 6 includes entries of vehicle ID, date, time period, and item. Identification information of the corresponding vehicle 2 is stored in the entry of vehicle ID. A date of the corresponding schedule is stored in the entry of date. That is, in the example illustrated in FIG. 6, the schedule is prepared for each date. Information indicating a time period is stored in the entry of time period.

Information of an item is stored in the entry of item. The information of an item is referred to as schedule information. For example, information indicating a type of the corresponding item is stored in the schedule information. Examples of the type of an item include traveling, downloading, and updating. The type of an item is not limited thereto. A program updating process includes a process of downloading updating data and a process of rewriting a target program with the updating data. In the first embodiment, when the type of an item in a schedule is updating, it means that the process of rewriting a target program with the updating data is performed.

When the type of an item is traveling, the schedule information includes, for example, information indicating whether the traveling is traveling for movement or traveling for providing a service, a departure location, a destination, and route information. The schedule information includes a start time and an end time of the item. The start time and the end time of an item are also referred to as a scheduled departure time and a scheduled arrival time. Examples of a service of providing traveling include a vehicle allocation service and a ride-sharing service. When the traveling is traveling for providing a service, the schedule information may include information on the service. Examples of the information on a service include user identification information and reservation information. The reservation information includes, for example, a desired boarding time, a scheduled arrival time, a boarding location, and an alighting location which are designated by a user. In the example illustrated in FIG. 6, items are arranged to correspond to a period from a start time to an end time. The route information includes, for example, a scheduled travel route, identification information and types of transit roads, and position information indicating transit points.

When the type of an item is downloading, the schedule information includes, for example, a start time and a file name to be downloaded. The schedule information may include a schedule end time of downloading. When the type of an item is updating, the schedule information includes, for example, a start time and identification information of updating data. One item may include a plurality of types. For example, when downloading is performed while a vehicle is traveling, the type of an item includes traveling and downloading.

For example, FIG. 6 illustrates a schedule for a vehicle of vehicle ID: E-PALETTE EV1 at a date DD/MM/YYYY. From 0:00 to 9:00, no item is set and the vehicle 2 of vehicle ID: E-PALETTE EV1 is on standby. The vehicle 2 of vehicle ID: E-PALETTE EV1 starts traveling at 9:00. The traveling at 9:00 is movement for a next schedule without a user therein. The vehicle 2 of vehicle ID: E-PALETTE EV1 performs traveling for providing a service from 9:45 to 11:00.

The vehicle 2 of vehicle ID: E-PALETTE EV1 performs traveling for movement and downloading in traveling from 11:00 to 12:00. At 12:00, the vehicle 2 of vehicle ID: E-PALETTE EV1 stops traveling and performs updating. Thereafter, the vehicle 2 of vehicle ID: E-PALETTE EV1 travels from 13:00 to 23:00 and stops its operation and is on standby at 23:00. In the example illustrated in FIG. 6, details of a schedule from 13:00 to 22:00 are omitted.

For example, when a schedule has been changed, the control unit 41 may transmit the whole schedule for one day to the vehicle 2 or extract and transmit schedule information of a changed item. For example, when an item of traveling for movement and downloading in traveling from 11:00 to 12:00 and an item of updating from 12:00 to 13:00 for the vehicle 2 of vehicle ID: E-PALETTE EV1 illustrated in FIG. 6 are added by receiving a release note, the control unit 41 may transmit the whole schedules of the date DD/MM/YYYY including the schedule information including the two items to the vehicle 2. Alternatively, the control unit 41 may transmit only the schedule information of the added two items to the vehicle 2. When another item has changed due to the added two items, the schedule information of the corresponding item is also transmitted to the vehicle 2.

The schedule illustrated in FIG. 6 is an example and the schedules prepared by the control center 4 are not limited to the example illustrated in FIG. 6. For example, an operation schedule may not be prepared for each date and may be prepared, for example, for each week. The operation schedule may be prepared for each month. The schedule may be prepared for each of week days (Monday to Friday), Saturday, and Sunday.

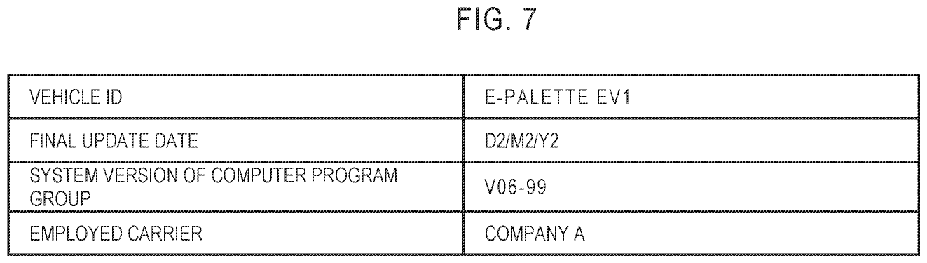

FIG. 7 illustrates an example of vehicle information stored in the vehicle information DB 42 of the control center 4. The vehicle information is information on a vehicle 2. The vehicle information is stored in the vehicle information DB 42 of the control center 4. In the example illustrated in FIG. 7, the vehicle information includes entries of vehicle ID, final update date, system version of the whole computer program group, and employed carrier.

Identification information of the corresponding vehicle 2 is stored in the entry of vehicle ID. An update date at which the corresponding vehicle 2 has finally updated the computer program group of the ECUs of the constituents is stored in the entry of final update date. A version of the updated computer program group in the corresponding vehicle 2 as a whole is stored in the entry of system version of the whole computer program group.

Information indicating a communication carrier employed in the corresponding vehicle 2 is stored in the entry of employed carrier. When a communication carrier is employed by the vehicle 2, it means, for example, that a SIM card of the communication carrier is inserted into the DCM 21. The information indicating a communication carrier is, for example, a code or a communication carrier name. When a plurality of communication carriers is employed by the vehicle 2, information indicating the plurality of communication carriers employed by the vehicle 2 is stored in the entry of employed carrier. When a plurality of communication carriers is employed by the vehicle 2, the control unit 41 may determine whether a communication environment is good or poor, for example, using a highest data rate out of the acquired data rates with reference to data rate map of the communication carriers employed by the vehicle 2. For example, when a communication carrier which is used is designated in the schedule, the control unit 41 refers to only the data rate map of the designated communication carrier. The vehicle information illustrated in FIG. 7 is an example and information included in the vehicle information is not limited to the example illustrated in FIG. 7.

Process Flow

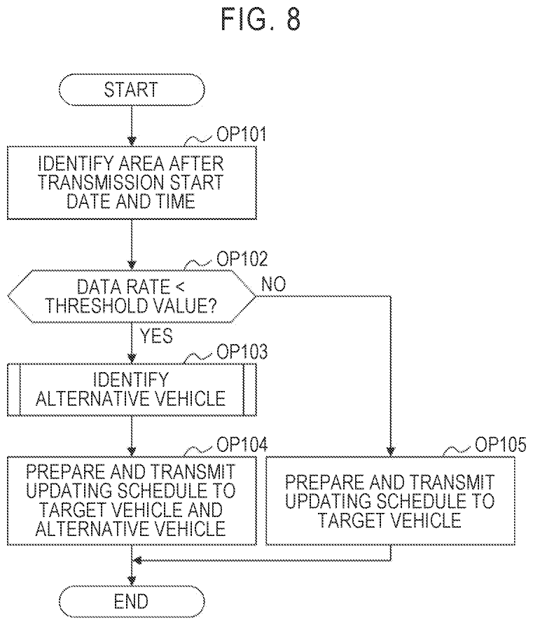

FIG. 8 illustrates an example of a flowchart of an updating schedule preparing process based on reception of a release note in the control center 4. The process flow illustrated in FIG. 8 is performed for each vehicle 2. The process flow illustrated in FIG. 8 is started when the control center 4 receives a release note for a vehicle 2 from the vehicle center 3. An entity that performs the process flow illustrated in FIG. 8 is the CPU 401 of the computer of the control center 4, but functional units will be described below as an entity for the purpose of convenience. This is the same for the following other flowcharts.

In OP101, the control unit 41 identifies an area in which a target vehicle is located after a transmission start date and time with reference to the schedule information DB 43. The area in which a target vehicle is located is, for example, a geographical scope including a travel route, a parking place, and a standby place of the target vehicle and a place in which maintenance is performed on the target vehicle.

In OP102, the control unit 41 determines whether a data rate obtained by the target vehicle in the area in which the target vehicle is located is less than a predetermined threshold value. The data rate obtained by the target vehicle is, for example, one of an average value, a median value, a minimum value, and a maximum value of data rates obtained by the target vehicle in the area in which the target vehicle is located. The data rate obtained by the target vehicle in the area in which the target vehicle is located is acquired, for example, based on a data rate map of a communication carrier employed by the target vehicle. The data rate map is, for example, via the Internet.

When the data rate obtained by the target vehicle in the area in which the target vehicle is located is less than the predetermined threshold value (OP102: YES), the process flow proceeds to OP103. In OP103, an alternative vehicle identifying process of identifying an alternative vehicle that will perform alternative downloading is performed. Details of the alternative vehicle identifying process of OP103 will be described later. Thereafter, the process flow proceeds to OP104.

In OP104, the control unit 41 prepares schedules for updating of the target vehicle for each of the target vehicle and the alternative vehicle and transmits the prepared schedules to the target vehicle and the alternative vehicle. The schedule prepared for the alternative vehicle includes a schedule including downloading updating data in traveling in a predetermined period after the transmission start date and time and a schedule including transmitting updating data to the target vehicle by short-range radio communication in a junction with the target vehicle while the alternative vehicle is not traveling. The schedule prepared for the target vehicle includes a schedule including receiving updating data from the alternative vehicle by short-range radio communication in a junction with the alternative vehicle in a predetermined period after the transmission start date and time and a schedule including updating the corresponding program with the updating data. The control unit 41 registers the schedules in the schedule information DB 43. Thereafter, the process flow illustrated in FIG. 8 ends.

When the data rate obtained by the target vehicle in the area in which the target vehicle is located is equal to or greater than the predetermined threshold value (OP102: NO), the process flow proceeds to OP105. When the data rate obtained by the target vehicle is equal to or greater than the predetermined threshold value, it means that the target vehicle can stably download the updating data. In OP105, the control unit 41 prepares a schedule including downloading the updating data from the vehicle center 3 and updating the corresponding program with the updating data in a time period in which the target vehicle is not traveling after the transmission start date and time and transmits the prepared schedule to the target vehicle. The control unit 41 registers the prepared schedule for the target vehicle in the schedule information DB 43. Thereafter, the process flow illustrated in FIG. 8 ends.

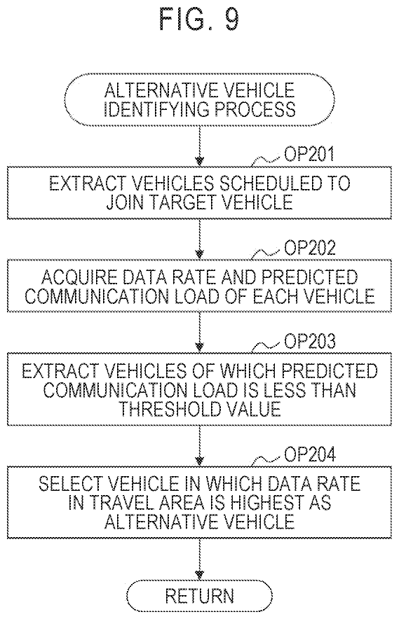

FIG. 9 illustrates an example of a flowchart of an alternative vehicle identifying process. The process flow illustrated in FIG. 9 is a routine which is performed in OP103 of FIG. 8. In OP201, the control unit 41 extracts, from the vehicles 2 under management, vehicles which are scheduled to join the target vehicle in a predetermined period after the transmission start date and time with reference to the schedule information DB 43. A schedule for joining the target vehicle is, for example, a schedule for performing standby, maintenance, or the like in the same place as the target vehicle.

In OP202, the control unit 41 acquires a data rate and a predicted communication load in the traveling area for each of the extracted vehicles 2 in a period from the transmission start date and time to a time point at which the corresponding vehicle is scheduled to join the target vehicle with reference to the schedule information DB 43. The data rate obtained in the traveling area of each vehicle 2 is one of an average value, a median value, a minimum value, and a maximum value of data rates acquired in the scheduled travel route of the vehicle 2, and the same as the data rate obtained in the area in which the target vehicle is located is used. The data rate obtained in the scheduled travel route of the vehicle 2 is acquired from a data rate map of a communication carrier employed by the vehicle 2. The predicted communication load of each vehicle 2 is acquired, for example, based on a type of a road in the travel route of the vehicle 2.

In OP203, the control unit 41 additionally extracts vehicles 2 in which the predicted communication load is less than a predetermined threshold value from the extracted vehicles 2. In OP204, a vehicle 2 in which a highest data rate is obtained in the traveling rea is selected as the alternative vehicle out of the vehicles 2 extracted in OP203. Thereafter, the process flow illustrated in FIG. 9 ends, and the process flow proceeds to OP104 of FIG. 8.

For example, it is assumed that the following three vehicles have been extracted (OP201 and OP202) as vehicles which are scheduled to join the target vehicle in a predetermined period after the transmission start date and time.
Vehicle A with a data rate of 50 Mbps and a predicted communication load of 90% in a traveling area (scheduled to travel on a general road)
Vehicle B with a data rate of 25 Mbps and a predicted communication load of 60% in a traveling area (scheduled to travel on a highway)
Vehicle C with a data rate of 35 Mbps and a predicted communication load of 60% in a traveling area (scheduled to travel on a highway)

When a threshold value for the predicted communication load is 80%, Vehicle B and Vehicle C of which the predicted communication load is 60% which is less than the threshold value are extracted (OP203). Since Vehicle C out of Vehicle B and Vehicle C has a higher data rate which is obtained in the traveling area, Vehicle C is selected as the alternative vehicle (OP204).

### Operations and Advantages of First Embodiment

In the first embodiment, when a communication environment of an area in which a vehicle 2 to be updated in a release note is located is poor, an alternative vehicle that will alternatively download updating data is selected. The target vehicle 2 receives the updating data from the alternative vehicle by short-range radio communication when it joins the alternative vehicle and updates a corresponding program with the updating data. Accordingly, even when a communication environment of an area in which a vehicle 2 to be updated is located is poor, the vehicle 2 can stably acquire updating data. As a result, even when a vehicle 2 is located in an area with a poor communication environment in a predetermined period after a transmission start date and time, the vehicle 2 can acquire the updating data at an earlier timing after the updating data has been transmitted and stably update the corresponding program.

### Other Modified Examples

The aforementioned embodiment is only an example and the present disclosure can be appropriately modified without departing from the gist thereof.

The processes or means described in the present disclosure can be unlimitedly combined unless technical conflictions arise.

A process which has been described to be performed by a single device may be divisionally performed by two or more devices. Alternatively, processes which have been described to be performed by different devices may be performed by a single device. In a computer system, by what hardware configuration (server configuration) each function is realized can be flexibly changed.

The present disclosure can also be realized by supplying a computer program in which the functions described above in the embodiment and the modified example are mounted to a computer and causing one or more processors of the computer to read and execute the program. This computer program may be provided to the computer using a non-transitory computer-readable storage medium which can be connected to a system bus of the computer or may be provided to the computer via a network. For example, the non-transitory computer-readable storage medium includes an arbitrary type of disk such as a magnetic disk (a floppy (registered trademark) disk or a hard disk drive (HDD) or an optical disc (such as a CD-ROM, a DVD disc, or a Blue-ray disc) or an arbitrary type of media suitable for storing electronic commands such as a read only memory (ROM), a random access memory (RAM), an erasable programmable ROM (EPROM), an electrically erasable programmable ROM (EEPROM), a magnetic card, a flash memory, or an optical card.

What is claimed is:

1. An information processing device comprising a control unit configured to perform:
selecting a first vehicle that is to download first data in place of a second vehicle while the first vehicle is traveling; and
instructing the first vehicle to download the first data in place of the second vehicle while the first vehicle is traveling and to transmit the first data to the second vehicle.

2. The information processing device according to claim 1, wherein the control unit is configured to select the first vehicle that is to download the first data out of a plurality of vehicles in place of the second vehicle based on a data rate on a scheduled travel route.

3. The information processing device according to claim 1, wherein the control unit is configured to select the first vehicle when a data rate in a scheduled travel route of the second vehicle is less than a first threshold value.

4. The information processing device according to claim 2, wherein the control unit is configured to select the first vehicle out of the plurality of vehicles additionally based on a communication load.

5. The information processing device according to claim 4, wherein the control unit is configured to select a vehicle in which the communication load is less than a second threshold value and the data rate is highest as the first vehicle out of a plurality of vehicles.

6. The information processing device according to claim 4, wherein the control unit is configured to acquire a communication load of each of the plurality of vehicles based on a type of a road included in a scheduled travel route of each of the plurality of vehicles.

7. The information processing device according to claim 1, wherein the control unit is configured to:
select the first vehicle out of a plurality of vehicles which is scheduled to join the second vehicle; and
instruct the first vehicle to transmit the first data to the second vehicle at a junction with the second vehicle.

8. The information processing device according to claim 1, wherein the first data is updating data of a program which is installed in the second vehicle, and
wherein the control unit is configured to further perform instructing the second vehicle to receive the first data from the first vehicle and to update the program with the first data.

9. The information processing device according to claim 1, wherein the first vehicle is configured to:
download the first data by first communication using a relay; and
transmit the first data to the second vehicle by second communication not using a relay.

10. An information processing method comprising:
selecting a first vehicle that is to download first data in place of a second vehicle while the first vehicle is traveling; and
instructing the first vehicle to download the first data in place of the second vehicle while the first vehicle is traveling and to transmit the first data to the second vehicle.

11. The information processing method according to claim 10, wherein the first vehicle that is to download the first data in place of the second vehicle is selected out of a plurality of vehicles based on a data rate on a scheduled travel route.

12. The information processing method according to claim 10, wherein the first vehicle is selected when a data rate in a scheduled travel route of the second vehicle is less than a first threshold value.

13. The information processing method according to claim 11, wherein the first vehicle is selected out of the plurality of vehicles additionally based on a communication load.

14. The information processing method according to claim 13, wherein a vehicle in which the communication load is less than a second threshold value and the data rate is highest out of a plurality of vehicles is selected as the first vehicle.

15. The information processing method according to claim 13, wherein a communication load of each of the plurality of vehicles is acquired based on a type of a road included in a scheduled travel route of each of the plurality of vehicles.

16. The information processing method according to claim 10, wherein the first vehicle is selected out of a plurality of vehicles which is scheduled to join the second vehicle, and
wherein the first vehicle is instructed to transmit the first data to the second vehicle at a junction with the second vehicle.

17. The information processing method according to claim 10, wherein the first data is updating data of a program which is installed in the second vehicle, and
wherein the information processing method further comprises instructing the second vehicle to receive the first data from the first vehicle and to update the program with the first data.

18. The information processing method according to claim 10, wherein the first vehicle is configured to:
download the first data by first communication using a relay; and
transmit the first data to the second vehicle by second communication not using a relay.

19. An information processing system comprising:
a plurality of vehicles; and
an information processing device including a control unit configured to perform:
selecting a first vehicle that is to download first data out of the plurality of vehicles in place of a second vehicle while the first vehicle is traveling; and
instructing the first vehicle to download the first data in place of the second vehicle while the first vehicle is traveling and to transmit the first data to the second vehicle.

20. The information processing system according to claim 19, wherein the control unit is configured to select the first vehicle that is to download the first data in place of the second vehicle based on a data rate on a scheduled travel route.
